(19) United States
(12) Patent Application Publication
(10) Pub. No.: US 2025/0303980 A1
(43) Pub. Date: Oct. 2, 2025

(54) VEHICLE REAR BODY STRUCTURE

(71) Applicant: SUBARU CORPORATION, Tokyo (JP)

(72) Inventor: Masanori TANAKA, Tokyo (JP)

(73) Assignee: SUBARU CORPORATION, Tokyo (JP)

(21) Appl. No.: 19/055,339

(22) Filed: Feb. 17, 2025

(30) Foreign Application Priority Data
Mar. 26, 2024 (JP) 2024-050378

(51) Int. Cl. B60R 13/08; B62D 25/08; B62D 43/10

(52) U.S. Cl. CPC B60R 13/0815; B62D 25/08; B62D 43/10

(57) ABSTRACT

A vehicle rear body structure comprising a panel member that is provided in a vehicle rear body of a vehicle, that serves as a partition between inside and outside of a cabin of the vehicle, and that propagates vibrational energy. The panel member has a first curved surface part that is smoothly curved surface and that is convex toward outside of a vehicle body of the vehicle.

### CROSS-REFERENCE TO RELATED APPLICATION

The present application claims priority from Japanese Patent Application No. 2024-050378 filed on Mar. 26, 2024, the entire contents of which are hereby incorporated by reference.

### BACKGROUND

The disclosure relates to a vehicle rear body structure.

As modern vehicles, vehicles driven solely by an engine (gasoline cars, diesel powered cars, etc.) are being replaced by widespread hybrid electric vehicles (HEVs), which are driven by an engine and an electric motor, and widespread electric vehicles (EVs), which are driven mainly by an electric motor.

Advanced electrification of vehicles eliminates, from electric vehicles, components of sound transmitted from the engine (noise caused by rotational components of engine). Also, hybrid electric vehicles, with an increased travel range in which they can solely be driven by an electric motor, travel like electric vehicles mainly in low-mid-load-operation ranges, thereby eliminating components of sound transmitted from the power train including an engine. As a result of this, the electrification of vehicles improves the quietness in the cabin in a travel range in which the vehicles are driven by an electric motor. In turn, indoor noise caused by road noise etc. becomes relatively noticeable.

Road noise is attributed to vibrations caused by irregularity on the road surface during the travel. For example, as illustrated in FIG. 6, when rear tires 2 of a vehicle 1 during travel pass on an irregular road surface, the vibrational energy is transmitted from the tires 2 to suspensions 3, a vehicle body frame 4, and a panel member 5 that is a relatively thin plate (for example, rear skirt panel), and is radiated as in-cabin sound. In-cabin sound caused by road noise is indoor noise, which irritates people in the cabin.

For example, Japanese Unexamined Patent Application Publication (JP-A) No. 2016-117346 discloses a technique in which a closed section is formed by a quarter inner lower and a shock absorber reinforce member on the front surface of the base of a rear skirt panel that is a panel member. The technique disclosed by this document forms a closed section with three types of members to increase the rigidity of the shock absorber reinforce member and the rear skirt panel, thereby reducing the in-cabin noise.

Incidentally, a rear skirt panel is a panel member serving as a partition between the inside and outside of the cabin. In front of this rear skirt panel, a vertical wall is provided that partitions the spare-tire storage formed in the luggage room. In the rear of the rear skirt panel, a rear bumper beam is provided. This makes it difficult to form a closed section that is sufficiently wide. Also, the structure of JP-A No. 2016-117346 uses three types of members to increase the rigidity. This complicates the fabrication.

A different technique is also known that employs a greater section modulus of the panel member 5 itself to increase the rigidity. For example, there is a technique that forms beads (libs) 5a as illustrated in FIG. 7. The beads 5a have a prescribed width in the longitudinal direction of the panel member 5 and are formed at prescribed intervals in the vehicle-widthwise direction. Forming the beads 5a in the panel member 5 results in a greater section modulus, thereby increasing the shape rigidity.

However, when forming the beads 5a on the panel member 5, the bending parts of the beads 5a often behave as an inflection point. When the beads 5a behave as an inflection point, vibrations are easily excited in the out-of-plane direction.

The dashed-dotted lines in FIG. 7 represent results of measuring the panel deformation amount of the panel member 5 by using a strain gauge etc. As illustrated in FIG. 7, the conventional panel member 5 is subject to great convex-concave deformation in the out-of-plane direction starting from the beads 5a when the beads 5a behave as an inflection point. In particular, panel deformation amount 2a in the in the out-of-plane direction peaks at the center of the panel member 5.

This deformation of the panel member 5 increases the in-cabin noise. Accordingly, forming the beads 5a on the panel member 5 causes only a limited effect for reducing the equivalent radiated power (ERP) from the panel member 5 although it can increase the rigidity.

### SUMMARY

An aspect of the disclosure provides a vehicle rear body structure including a panel member that is provided in a vehicle rear body of a vehicle, that serves as a partition between inside and outside of a cabin of the vehicle, and that propagates vibrational energy. The panel member has a first curved surface part that is smoothly curved surface and that is convex toward outside of a vehicle body of the vehicle.

### BRIEF DESCRIPTION OF THE DRAWINGS

FIG. 1 is a perspective view schematically illustrating a vehicle rear body structure;

FIG. 2 is a front view of a rear skirt panel;

FIG. 3 is a sectional view along III-III of FIG. 1;

FIG. 4 is a plan sectional view along IV-IV of FIG. 3 and illustrating a vehicle rear body in its lower side of the view;

FIG. 5 is a perspective view schematically illustrating a vehicle rear body structure according to a variation embodiment;

FIG. 6 is a side view of a vehicle exhibiting propagation of vibrational energy; and

FIG. 7 is a plan sectional view illustrating a conventional panel member in which beads are formed.

### DETAILED DESCRIPTION

It is desirable to provide a vehicle rear body structure that is easy to fabricate, that can reduce the equivalent radiated power without reducing the rigidity of the panel member, and that further can achieve weight saving.

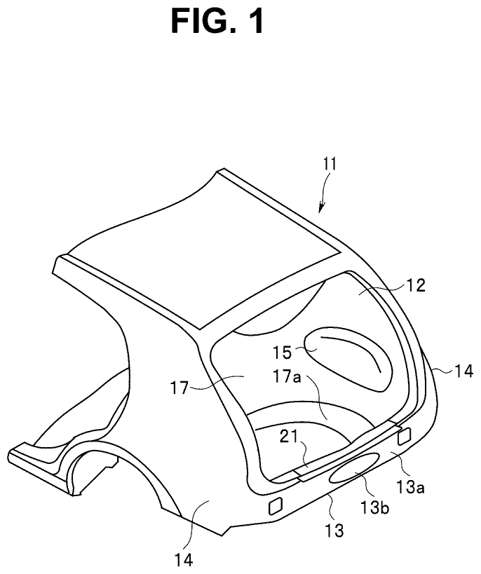

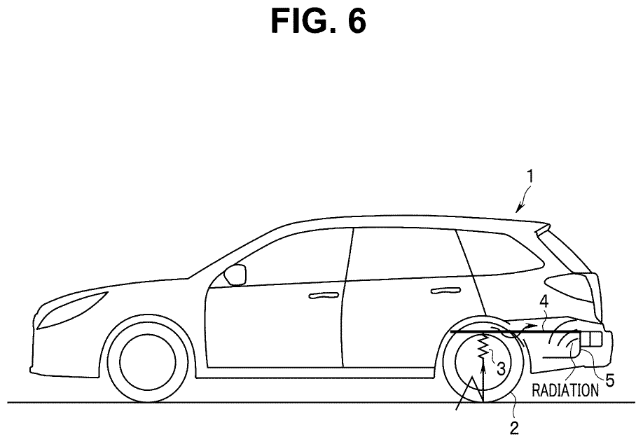

Hereinafter, an embodiment of the disclosure will be explained by referring to the drawings. In FIG. 1, numeral 11 denotes a vehicle rear body. This vehicle rear body 11 illustrates a rear-side vehicle body of the vehicle 1 of FIG. 6. Note that the entire vehicle body employs a monocoque structure resulting from integrally joining the panel member and the vehicle body frame member.

At the back of this vehicle rear body 11, a rear gate opening 12 is formed. This rear gate opening 12 is opened and closed by a rear gate (not illustrated). The rear gate is a flip-up type for the opening and closing of the rear gate.

Under the rear gate opening 12, a rear skirt panel 13, which is a panel member, is provided. This rear skirt panel 13 extends in the vehicle-widthwise direction along the lower edge of the rear gate opening 12. This rear skirt panel 13 has its both ends joined to a rear part of a side structure 14.

This side structure 14 extends forward along the side edges of the rear gate opening 12 and the side parts of the vehicle body. Numeral 15 denotes a rear-side wheel house. This rear-side wheel house 15 is formed in a rear part of the side structure 14.

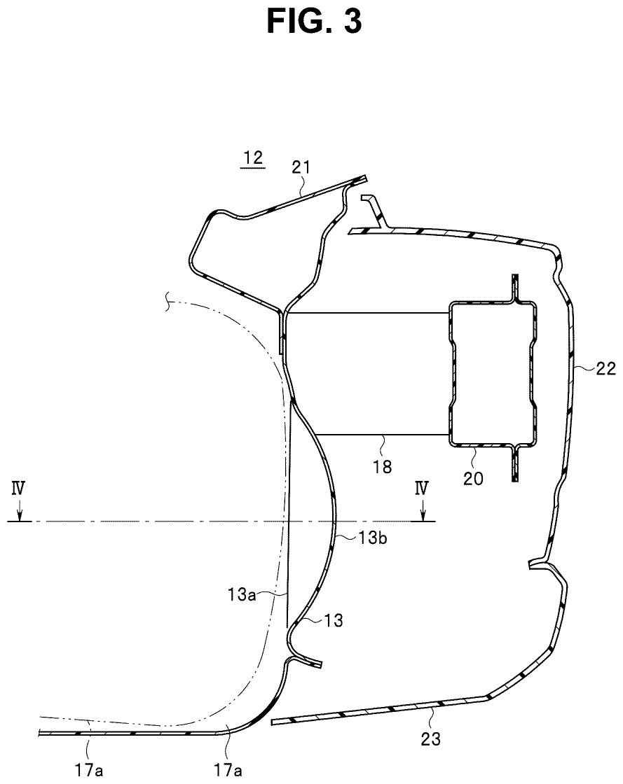

Also, on the right and left of the vehicle rear body, rear side frames 16 are provided as a vehicle body frame. These rear side frames 16 have front ends continuing to floor side frames (not illustrated). Further, extensions 18 at the rear ends of these rear side frames 16 are joined. Also, the right and left extensions 18 are linked via a rear bumper beam 20 (see FIG. 3). This rear bumper beam 20 extends in the vehicle-widthwise direction.

Also, the rear end of a rear floor panel 17 is joined to the front end of the rear skirt panel 13. Further, the right and left edges of the rear side of this rear floor panel 17 are joined to the rear side frame 16. Further, a spare-tire storage recess 17a is formed on the side, of this rear floor panel 17, closer to the rear skirt panel 13. This spare-tire storage recess 17a stores a spare tire 19.

The rear skirt panel 13 comprises a vertical wall 13a oriented toward the rear of the vehicle body. As illustrated in FIG. 3, this vertical wall 13a constitutes at least part of the rear wall of the spare-tire storage recess 17a. Also, the lower end part of the vertical wall 13a and the rear end part of the rear floor panel 17 are joined. The rear end part of the rear floor panel 17 forms the bottom of the spare-tire storage recess 17a. Further, the vertical wall 13a has its vehicle-widthwise end parts joined to the end part of the rear floor panel 17 that forms the rising portion of the spare-tire storage recess 17a.

This rear skirt panel 13 has a rear skirt panel bracket 21 fixed to its upper end part. This rear skirt panel bracket 21 constitutes the lower end surface of the rear gate opening 12. This rear skirt panel bracket 21 extends in the vehicle-widthwise direction along the lower end surface of the rear gate opening 12.

Also, the rear skirt panel 13 and the rear bumper beam 20 have their rear parts covered by a bumper face 22 made of a resin. Further, the bumper face 22 and the spare-tire storage recess 17a respectively have their lower end and rear end covered by a bumper guard 23.

As illustrated in FIG. 1 through FIG. 3, the vertical wall 13a of the rear skirt panel 13 extend in the vehicle-widthwise direction. A curved surface part 13b is formed at the vehicle-widthwise middle of the vertical wall 13a and generally at the middle in the vertical direction of the vertical wall 13a. The rear skirt panel 13, which is a relatively thin plate, has the lowest rigidity at its vehicle-widthwise middle. Forming the curved surface part 13b at the vehicle-widthwise middle of this rear skirt panel 13 can increase the entire rigidity of the rear skirt panel 13.

Also, the vertical wall 13a constitutes at least part of the rear wall of the spare-tire storage recess 17a. This ensures such a sufficient space out of a narrow space that the curved surface part 13b can be deformed to become convex toward the rear of the vehicle body.

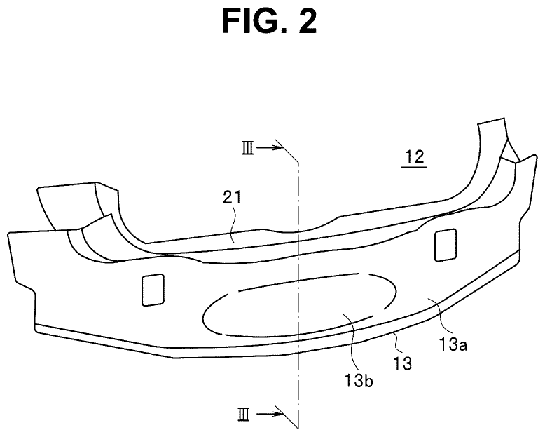

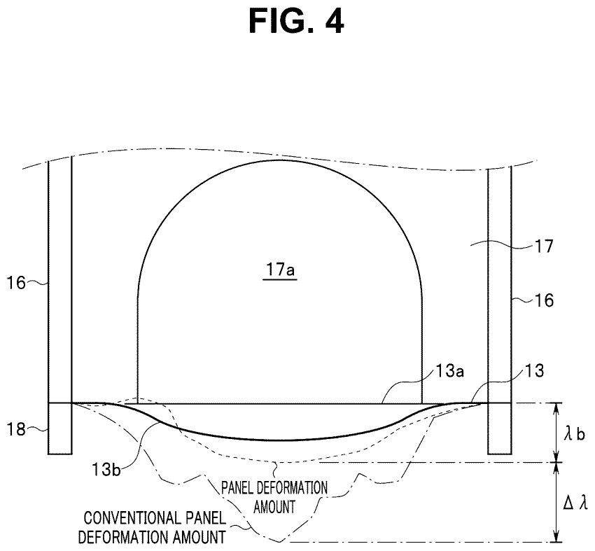

As illustrated in FIG. 1 and FIG. 2, this curved surface part 13b is formed as an oval that is long in the vehicle-widthwise direction. As illustrated in FIG. 3 and FIG. 4, this curved surface part 13b is formed to be convex toward the rear by a surface curved slightly and smoothly with respect to the vertical wall 13a. That is, the curved surface part 13b is adjacent to at least a part of the vertical wall 13a, and a curvature of the curved surface part 13b may be greater than a curvature of the part of the vertical wall 13a. The vertical wall 13a may be a flat surface with respect to the curved surface part 13b that is a curved surface.

Next, effects in the present embodiment that can be caused by the above configuration will be explained. As explained with reference to FIG. 6, road noise is attributed to vibrations caused by irregularity on the road surface during the travel.

When the rear tires 2 of the vehicle 1 during travel pass on an irregular road surface, the vibrational energy is propagated from the tires 2 to the suspensions 3. The vibrational energy propagated to the suspensions 3 is propagated toward the rear via the rear side frames 16 and the rear floor panel 17 illustrated in FIG. 4. This vibrational energy excites vibrations of the rear skirt panel 13, and, in the case of a completed vehicle, is radiated as in-cabin sound of the vehicle 1 (see FIG. 6).

The vertical wall 13a of the rear skirt panel 13 at its vehicle-widthwise middle is the most easily excited in the out-of-plane direction. At the vehicle-widthwise middle of the vertical wall 13a according to the present embodiment, the curved surface part 13b that is an oval long in the vehicle-widthwise direction is formed. The curved surface part 13b is formed to be convex toward the rear of the vehicle body by a surface curved slightly and smoothly with respect to the vertical wall 13a. This results in no elements of inflection point in the curved surface part 13b. This enables the vibrational energy to be received over a broad plane of the vertical wall 13a, thereby reducing the panel deformation amount.

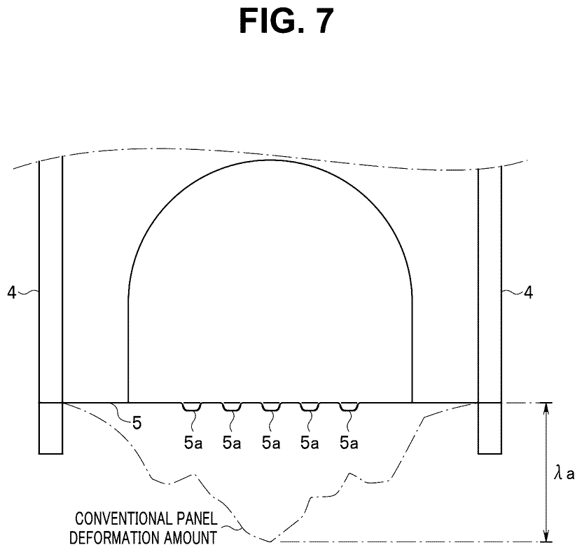

The dashed line of FIG. 4 represents a result of measuring the panel deformation amount of the rear skirt panel 13 by using a strain gauge etc. Comparison between panel deformation amount Ab at the vehicle-widthwise middle, which represents the greatest deformation amount, and conventional panel deformation amount λa of FIG. 7 indicates the reduction by variation amount difference Δλ.

The reduced panel deformation amount λb of the rear skirt panel 13 can decrease, by the reduced amount, the equivalent radiated power (ERP) entering the cabin from the rear skirt panel 13.

As described above, in the present embodiment, the curved surface part 13b that is deformed to become convex toward the rear of the vehicle body is formed at the vehicle-widthwise middle, which has the lowest rigidity in the vertical wall 13a provided to the rear skirt panel 13. This curved surface part 13b can increase the entire rigidity of the rear skirt panel 13.

Also, this curved surface part 13b is formed to be slightly and smoothly curved. This results in a simple structure involving no inflection points in the vertical wall 13a, thereby enabling the reduction in the equivalent radiated power entering the cabin from the rear skirt panel 13. The rear skirt panel 13 can be thinner by the amount of the reduction in the equivalent radiated power, thereby achieving further weight saving. Also, the simple structure, which is achieved just by forming the curved surface part 13b at the vehicle-widthwise middle of the vertical wall 13a, is easy to fabricate.

### Variation Example

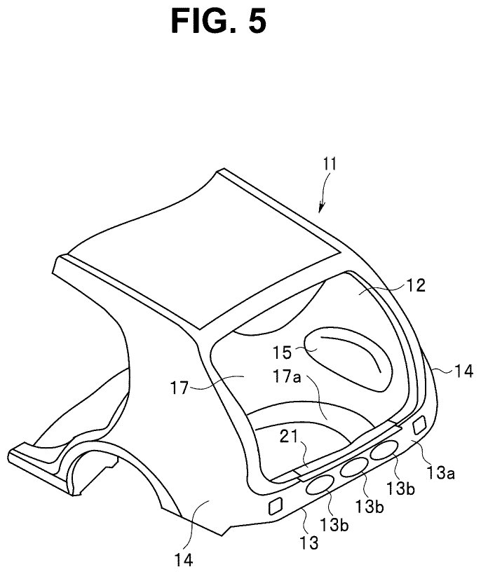

FIG. 5 illustrates a variation embodiment. Like elements corresponding to those of FIG. 1 are denoted by like numerals, and explanations thereof will be omitted.

The vehicle rear body 11 illustrated in FIG. 5 comprises multiple curved surface parts 13b formed in the vehicle-widthwise direction in the vertical wall 13a of the rear skirt panel 13. Forming multiple curved surface parts 13b in the vertical wall 13a can increase the entire rigidity of the rear skirt panel 13. This results in the reduction in the equivalent radiated power, achieving relatively advanced weight saving.

The disclosure is not limited to the above disclosed embodiments, and for example, the panel member that forms the curved surface part 13b is not limited to the rear skirt panel 13, and may be the rear floor panel 17 or other rear panel members, as long as it serves as a partition between the inside and outside of the cabin.

According to the disclosure, a simple structure, which is achieved just by forming in a panel member a smoothly curved surface part that deforms to become convex toward the outside of the vehicle body, can be fabricated easily, and it is possible to reduce the equivalent radiated power without reducing the rigidity of the panel member and to further achieve weight saving.

1. A vehicle rear body structure comprising a panel member that is provided in a vehicle rear body of a vehicle, that serves as a partition between inside and outside of a cabin of the vehicle, and that propagates vibrational energy, wherein
the panel member has a first curved surface part that is smoothly curved surface and that is convex toward outside of a vehicle body of the vehicle.

2. The vehicle rear body structure according to claim 1, wherein
the panel member is a rear skirt panel provided to the vehicle rear body,
the rear skirt panel includes a vertical wall that is oriented toward a rear of the vehicle body, and
the vertical wall has the first curved surface part.

3. The vehicle rear body structure according to claim 2, wherein
the first curved surface part is disposed at a center of the vertical wall in a vehicle-widthwise direction of the vehicle.

4. The vehicle rear body structure according to claim 2, wherein
the vertical wall has curved surface parts spaced apart from one another in a vehicle-widthwise direction of the vehicle, and
the curved surface parts includes the first curved surface part, and a second curved surface part that is smoothly curved surface and that is convex toward outside of the vehicle body of the vehicle.

5. The vehicle rear body structure according to claim 2, wherein
a tire storage recess is formed in the vehicle rear body, and
at least a part of a rear wall of the tire storage recess is constituted of the vertical wall.

6. The vehicle rear body structure according to claim 3, wherein
a tire storage recess is formed in the vehicle rear body, and
at least a part of a rear wall of the tire storage recess is constituted of the vertical wall.

7. The vehicle rear body structure according to claim 4, wherein
a tire storage recess is formed in the vehicle rear body, and
at least a part of a rear wall of the tire storage recess is constituted of the vertical wall.
